(19) United States
(12) Patent Application Publication
(10) Pub. No.: US 2023/0373025 A1
(43) Pub. Date: Nov. 23, 2023

(54) METHOD FOR PRODUCING WELDED ARTICLE

(71) Applicant: TOYOTA JIDOSHA KABUSHIKI KAISHA, Toyota-shi (JP)

(72) Inventor: Toru SUGIYAMA, Toyota-shi (JP)

(73) Assignee: TOYOTA JIDOSHA KABUSHIKI KAISHA, Toyota-shi (JP)

(21) Appl. No.: 18/309,228

(22) Filed: Apr. 28, 2023

(30) Foreign Application Priority Data
May 17, 2022 (JP) 2022-080661

(51) Int. Cl. B23K 15/00; B23K 26/26

(52) U.S. Cl. CPC B23K 15/0006; B23K 15/006; B23K 26/26; B23K 2101/12

(57) ABSTRACT

Provided is a method for producing a welded article. The method welds a plurality of members by laser welding or electron beam welding to form a welded portion and produce a welded article having an internal space. The method includes forming the welded portion surrounding the internal space, and at least one of forming an end point portion of the welded portion outside of the welded portion surrounding the internal space, forming the welded portion by moving a laser or an electron beam from the inside to the outside of the outer edge of the plurality of members, forming another welded portion overlapping with the end point portion of the welded portion previously formed, or forming the end point portion of the welded portion in a region surrounded by the welded portion partitioning the internal space.

### CROSS REFERENCE TO RELATED APPLICATIONS

The present application claims priority from Japanese patent application JP 2022-080661 filed on May 17, 2022, the entire content of which is hereby incorporated by reference into this application.

### BACKGROUND

### Technical Field

The present disclosure relates to a method for producing a welded article.

### Background Art

Conventionally, methods for joining aluminum members by laser welding are known. For example, JP H07-100675 A discloses a method for joining aluminum members, including spraying an Al—Si based alloy filler metal onto the surface to be joined of at least one of two aluminum members to be joined to form a filler metal coating and then assembling these members to join them together by laser welding (paragraph 0005, claim 1, Abstract, etc.).

According to this conventional method for joining aluminum members, in joining members to be joined that are highly sensitive to solidification cracking, high-speed laser welding can be achieved without a decrease in the welding speed due to the speed of supplying a filler metal that occurs in the other conventional methods, and the joining work itself can be simplified (JP H07-100675 A, paragraph 0016).

There is also known a bus bar that can be welded to the external terminals of electronic components without weld cracking of the bus bar, even if a filler metal is not used. JP 2015-015211 A discloses a bus bar including a plurality of terminal portions made of 1000 series aluminum to be connected to the external terminals of electronic components and a main body made of a 6000 series aluminum alloy to link these terminal portions, in which the terminal portions and the main body are integrated by friction stir joining (JP 2015-015211 A, paragraph 0009, claim 1, Abstract, etc.).

According to this conventional bus bar, excellent welding property can be obtained since the terminal portions to be connected to the external terminals of the electronic components are made of 1000 series aluminum, and the joining can favorably be achieved without weld cracking even if a filler metal is not used in welding the terminal portions to the external terminals of the electronic components. In addition, since the welding does not use a filler metal, the electric conductivity will not be decreased due to the filler metal, and the energy loss in coupling of bus bars can be reduced. Furthermore, since there is no need for associated works such as condition settings and management for supplying a filler metal, excellent welding workability can be obtained (JP 2015-015211 A, paragraph 0015).

### SUMMARY

As described above, the conventional method for joining aluminum members requires a preparation work of spraying an Al—Si based alloy filler metal onto the surface to be joined of the member to be joined to form a filler metal coating before assembling the members to join them together by laser welding. Thus, an increase in the number of welding spots relative to the area of the members to be joined will make the welding of the members complicated due to increased preparation works.

In addition, the above-stated conventional bus bar requires friction stir joining of the portions made of 1000 series aluminum and the portions made of a 6000 series aluminum alloy as described above. The friction stir joining may be hard to apply if the number of welding spots relative to the area of the members to be joined increases.

The present disclosure provides a method for producing a welded article, which is easily applied even with an increased number of welding spots, simplifies welding, and can avoid an influence of cracking that may occur in an end point portion of a linear welded portion on an internal space of the welded article.

One aspect of the present disclosure is a method for producing a welded article by welding a plurality of members by laser welding or electron beam welding to form a welded portion and produce a welded article having an internal space. The method includes a periphery welding step of forming the welded portion surrounding the internal space, and further includes at least one of an outside terminating step of forming an end point portion of the welded portion outside of the welded portion surrounding the internal space, an outer edge intersecting step of forming the welded portion by moving a laser in the laser welding or an electron beam in the electron beam welding from an inside to an outside of an outer edge of the plurality of members, an overlap welding step of forming another welded portion overlapping with the end point portion of the welded portion previously formed, or an end surrounding step of forming the end point portion of the welded portion in a region surrounded by the welded portion partitioning the internal space.

The method for producing a welded article according to the above aspect may include at least the outside terminating step or the outer edge intersecting step. In addition, the method for producing a welded article according to the above aspect may include at least the overlap welding step and the end surrounding step. In addition, in the method for producing a welded article according to the above aspect, the welded portion may include straight portions extending linearly and a curved portion formed between the straight portions extending in different directions, and a contained angle between the straight portions on opposite sides of the curved portion may be 90 degrees or greater.

According to the above aspects of the present disclosure, it is possible to provide a method for producing a welded article, which is easily applied even with an increased number of welding spots, simplifies welding, and can avoid an influence of weld cracking that may occur in an end point portion of a linear welded portion on an internal space of the welded article.

### BRIEF DESCRIPTION OF THE DRAWINGS

FIG. 1 is a flowchart of one embodiment of a method for producing a welded article of the present disclosure;

FIG. 2 is a cross-sectional view of an example of a welded article that is produced by the method for producing a welded article of FIG. 1;

FIG. 3 is a bottom view of the welded article of FIG. 2;

FIG. 4 is a top view of the welded article of FIG. 2;

FIG. 5 is an enlarged view of the welded portion showing the V portion of the welded article of FIG. 4;

FIG. 6 is an enlarged view of the welded portion showing a modification of the welded article of FIG. 5;

FIG. 7 is an enlarged view of the welded portion showing the VII portion of the welded article of FIG. 4;

FIG. 8 is an enlarged view of the welded portion showing a modification of the welded article of FIG. 7;

FIG. 9 is an enlarged view of the welded portion showing the IX portion of the welded article of FIG. 4;

FIG. 10 is an enlarged view of the welded portion showing the X portion of the welded article of FIG. 9;

FIG. 11 is an enlarged view of the welded portion showing a modification of the welded article of FIG. 7;

FIG. 12 is an enlarged view of the welded portion showing the XII portion of the welded article of FIG. 9; and

FIG. 13 is an enlarged view of the welded portion showing the XIII portion of the welded article of FIG. 4.

### DETAILED DESCRIPTION

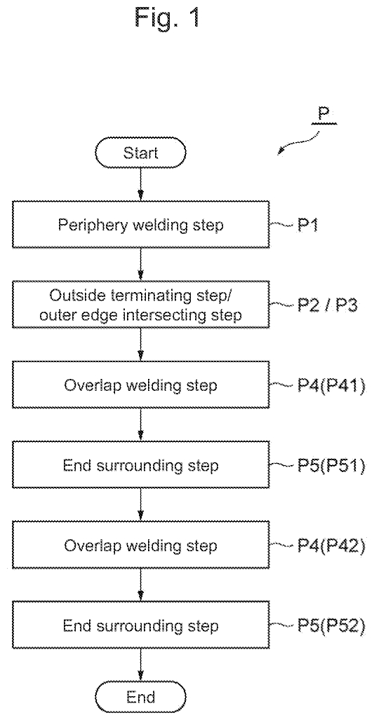

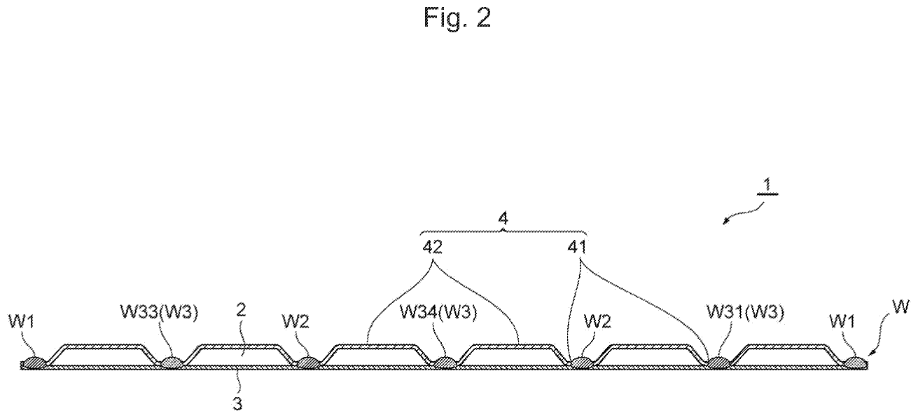

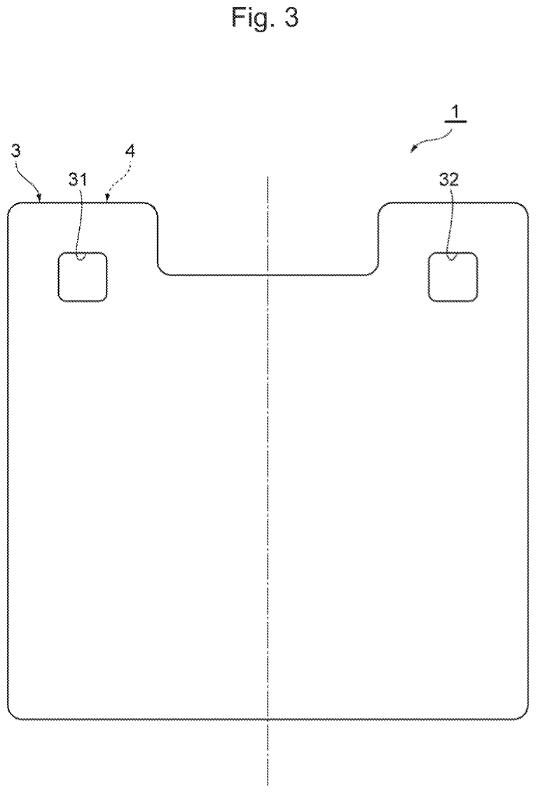

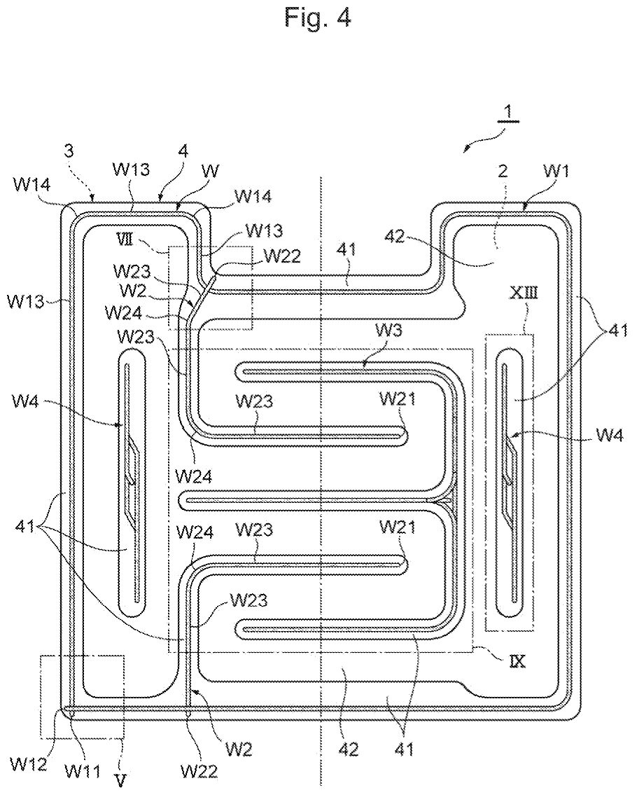

Hereinafter, an embodiment of a method for producing a welded article of the present disclosure will be described with reference to the drawings. FIG. 1 is a flowchart of one embodiment of the method for producing a welded article of the present disclosure. FIG. 2 is a cross-sectional view of an example of a welded article 1 that is produced by the method P for producing a welded article of FIG. 1. FIG. 3 is a bottom view of the welded article 1 of FIG. 2. FIG. 4 is a top view of the welded article 1 of FIG. 2. It should be noted that the cross section of the welded article 1 of FIG. 2 is along the center line of the welded article 1 shown in FIG. 3 and FIG. 4.

The method P for producing a welded article of the present embodiment welds a plurality of members by laser welding or electron beam welding to form a welded portion W and produce the welded article 1 having an internal space 2. As shown in FIG. 1, the method P for producing a welded article of the present embodiment includes a periphery welding step P1. In addition to the periphery welding step P1, the method P for producing a welded article of the present embodiment includes an outside terminating step P2 or an outer edge intersecting step P3, for example. Further, the method P for producing a welded article of the present embodiment includes an overlap welding step P4 and an end surrounding step P5. It should be noted that, in addition to the periphery welding step P1, the method P for producing a welded article of the present embodiment may include at least one of the outside terminating step P2, the outer edge intersecting step P3, the overlap welding step P4, or the end surrounding step P5.

The welded article 1 produced by the method P for producing a welded article of the present embodiment is made up of a plurality of members welded by laser welding or electron beam welding. In the examples shown in FIG. 2 to FIG. 4, the welded article 1 is made up of a plurality of plate members. More specifically, the welded article 1 includes a flat underplate 3 and a top plate 4 with a concave and convex shape, for example.

The welded article 1 includes the internal space 2 between the plurality of welded members. In the example shown in FIG. 2, the top plate 4 includes a flat portion 41 contacting the underplate 3 and a bulging portion 42 that bulges in a direction opposite to the underplate 3 to form the internal space 2 between the bulging portion 42 and the underplate 3. More specifically, in the present embodiment, the welded article 1 is a cooler, for example, and the internal space 2 of the welded article 1 is a refrigerant passage of the cooler. As shown in FIG. 3, the underplate 3 includes a refrigerant inlet 31 and a refrigerant outlet 32.

As shown in FIG. 4, the bulging portion 42 of the top plate 4 has a shape corresponding to the shape of the internal space 2 between the bulging portion 42 and the underplate 3. The internal space 2 of the welded article 1 of the present embodiment is a refrigerant passage of the cooler including a plurality of branch portions and curved portions, for example, and as shown in FIG. 3, a refrigerant is supplied and discharged via the refrigerant inlet 31 and the refrigerant outlet 32 that are open in the underplate 3. As shown in FIG. 2 and FIG. 4, the flat portion 41 of the top plate 4 is welded to the underplate 3 by laser welding or electron beam welding to form a linear welded portion W.

It should be noted that the welded article 1 is not limited to the cooler, and may be, for example, a heat exchanger or tank made up of a plurality welded members and having the internal space 2 surrounded by a linear welded portion B. In addition, the welded article 1 may be made up of three or more welded plate members. Examples of the material of the plurality of members of the welded article 1 include a metal material such as a 2000 series (Al—Cu based), 3000 series (Al—Mn based), or 4000 series (Al—Si based) aluminum alloy.

The method P for producing a welded article of the present embodiment is particularly effective when the material of the plurality of members of the welded article is a 5000 series (Al—Mg based), 6000 series (Al—Mg—Si based), or 7000 series (Al—Zn—Mg light alloy) aluminum alloy or the like, for example. Hereinafter, each step of the method P for producing a welded article of the present embodiment will be described in detail.

As shown in FIG. 1, when the method P for producing a welded article of the present embodiment is started, the periphery welding step P1 is performed, for example. In the periphery welding step P1, the welded portion W surrounding the internal space 2 is formed. More specifically, as shown in FIG. 2, the top plate 4 is disposed on the underplate 3 such that the flat portion 41 of the top plate 4 and the underplate 3 overlap each other. Then, by laser welding or electron beam welding, the periphery of the bulging portion 42 of the top plate 4 that forms the internal space 2 with the underplate 3 is continuously welded to form a peripheral welded portion W1 that is the welded portion W continuously surrounding the entire periphery of the bulging portion 42 as shown in FIG. 4.

The peripheral welded portion W1 includes a plurality of straight portions W13 extending linearly along the outer edge of the top plate 4 and a plurality of curved portions W14 each formed between the adjacent straight portions W13, W13 extending in different directions. In the example shown in FIG. 4, each curved portion W14 is formed into a circular arc, and the contained angle between the straight portions W13, W13 on the opposite sides of each curved portion W14 is 90 degrees.

In one example, the conditions in the case of laser welding of the underplate 3 and the top plate 4 having a thickness of 0.8 mm and made of a 6000 series aluminum alloy (A6061-T6) may include a laser spot size of 0.6 mm, a laser output of 2.8 kW, and a laser-scanning speed of 5 m/min. It should be noted that these conditions are examples, and it is needless to mention that the conditions may vary depending on the welding method, the thickness and material of the members to be welded, and the like. In the case of laser welding, continuous wave (CW) laser welding may be employed, for example. However, as long as a continuous linear welded portion W may be formed, the type of laser welding is not limited to the CW laser welding.

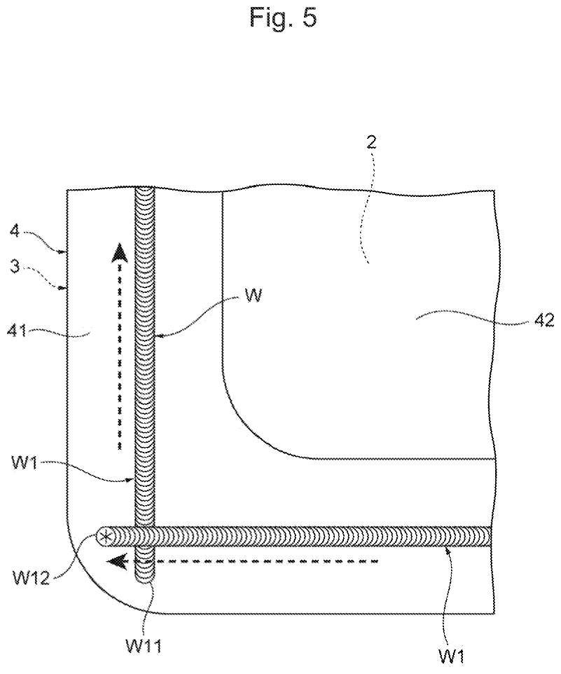

FIG. 5 is an enlarged view of the welded portion W showing the V portion of the welded article 1 of FIG. 4. As shown in FIG. 4 and FIG. 5, in the periphery welding step P1, welding of the underplate 3 and the top plate 4 is started from a given point of the peripheral portion of the top plate 4 where the underplate 3 and the flat portion 41 of the top plate 4 overlap each other, such as a lower left corner of the top plate 4, for example, and a starting point portion W11 of the welded portion W is formed. Then, from the starting point portion W11, the welded portion W is linearly formed in the peripheral portion of the top plate 4 along one side edge of the top plate 4, such as a left edge, for example, and further the welded portion W is linearly formed along another side edge of the top plate 4 to form the welded portion W throughout the entire peripheral portion of the top plate 4.

Then, finally, as shown in FIG. 5, the welded portion W is formed so as to intersect the welded portion W formed along the one side edge of the top plate 4, where the welding has been started, such that the peripheral welded portion W1 surrounding the entire periphery of the internal space 2 between the bulging portion 42 of the top plate 4 and the underplate 3 is formed. That is the end of the periphery welding step P1, and consecutively the outside terminating step P2 is performed. In the outside terminating step P2, as shown in FIG. 5, the welded portion W intersecting the first formed welded portion W is continuously extended to form an end point portion W12 of the welded portion W outside of the frame-shaped peripheral welded portion W1 that is the welded portion W surrounding the internal space 2.

When the members of the welded article 1 are made of a 5000 series, 6000 series, or 7000 series aluminum alloy or the like, for example, cracking tends to occur in the end point portion W12 of the welded portion W. It is considered that this is because the end point portion W12 of the welded portion W, which does not accompany a following welded portion W, will not be supplied with molten metal from any following portion during solidification of the molten metal, and thus more stress acts on the end point portion W12 during solidification of the molten metal than the other portions.

Even when cracking occurs in the end point portion W12 of the welded portion W, since the outside terminating step P2 is performed to form the end point portion W12 of the welded portion W outside of the frame-shaped peripheral welded portion W1 that is the welded portion W surrounding the internal space 2, the influence of the cracking on the internal space 2 of the welded article 1 can be avoided. That is, the peripheral welded portion W1 surrounding the internal space 2 may ensure the sealing property of the peripheral portion of the internal space 2, and thus even when cracking occurs in the end point portion W12 of the welded portion W outside of the peripheral welded portion W1, the sealing property of the peripheral portion of the internal space 2 will not decrease.

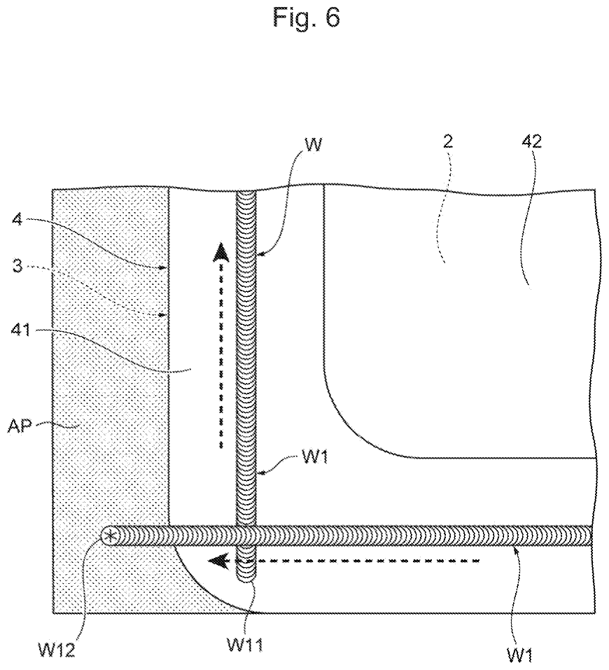

FIG. 6 is an enlarged view of the welded portion W showing a modification of the welded article 1 of FIG. 5. As shown in FIG. 1, in the method P for producing a welded article of the present embodiment, after the periphery welding step P1, the outer edge intersecting step P3 may be performed instead of the outside terminating step P2. Like the outside terminating step P2 shown in FIG. 5, for example, after the end of the periphery welding step P1 of forming the peripheral welded portion W1 surrounding the entire periphery of the internal space 2, the outer edge intersecting step P3 may be consecutively performed.

In the outer edge intersecting step P3, as shown in FIG. 6, the welded portion W is formed by moving the laser in laser welding or the electron beam in electron beam welding from the inside to the outside of the outer edge of the top plate 4 and the underplate 3 that are the members of the welded article 1. Thus, the peripheral portion of the top plate 4 and the underplate 3 that are the members of the welded article 1 no longer includes the end point portion W12 of the welded portion W.

The end point portion W12 of the welded portion W is an end of the welded portion W that has continuously been formed. In the example shown in FIG. 5, the end point portion W12 is formed inside of the outer edge of the top plate 4 and the underplate 3 that are the members of the welded article 1. That is, between the end point portion W12 of the welded portion W and the outer edge of the top plate 4, there is a portion not including the welded portion W. In this case, cracking tends to occur in the end point portion W12 of the welded portion W as described above.

On the other hand, in the outer edge intersecting step P3, as shown in FIG. 6, the welded portion W is formed so as to intersect the outer edge of the top plate 4 and the underplate 3 that are the members of the welded article 1, and the peripheral portion of the top plate 4 and the underplate 3 no longer includes the end point portion W12 of the welded portion W. In the example shown in FIG. 6, the outer edge of an auxiliary plate AP made of the same material as the top plate 4 and the underplate 3 abuts on the outer edge of the top plate 4 and the underplate 3 that are the members of the welded article 1.

In this state, the laser in laser welding or the electron beam in electron beam welding is moved from the inside to the outside of the outer edge of the top plate 4 and the underplate 3, so as to continuously form the welded portion W from the top plate 4 and the underplate 3 to the auxiliary plate AP and form the end point portion W12 of the welded portion W in the auxiliary plate AP. Thus, the portion of the welded portion W intersecting the outer edge of the top plate 4 and the underplate 3 is supplied with molten metal from the following welded portion W formed in the auxiliary plate AP, and cracking can be avoided. After that, the welded portion W is cut at the outer edge of the top plate 4 and the underplate 3.

It should be noted that the auxiliary plate AP may not be used in the outer edge intersecting step P3. In this case, by moving the laser in laser welding or the electron beam in electron beam welding from the inside to the outside of the outer edge of the top plate 4 and the underplate 3 that are the members of the welded article 1, the outer edge of the top plate 4 and the underplate 3 melts and solidifies to form the welded portion W. The terminal of this welded portion W differs from the end point portion W12 shown in FIG. 5 in that, between the terminal of this welded portion W and the outer edge of the top plate 4 and the underplate 3, the top plate 4 and the underplate 3 do not include a portion without the welded portion W. Accordingly, the terminal of the welded portion W solidifies while shrinking inwardly with respect to the outer edge of the top plate 4 and the underplate 3, and thus less stress acts thereon during solidification, and cracking can be avoided.

In the method P for producing a welded article of the present embodiment, the outside terminating step P2 and the outer edge intersecting step P3 include, for example, the step of forming a passage forming welded portion W2 which will be described below. The passage forming welded portion W2 is a part of the welded portion W shown in FIG. 4, and extends from the inside to the outside of the peripheral welded portion W1 surrounding the internal space 2. As shown in FIG. 2, for example, the passage forming welded portion W2 partitions the internal space 2 of the welded article 1 to form a refrigerant passage in the internal space 2.

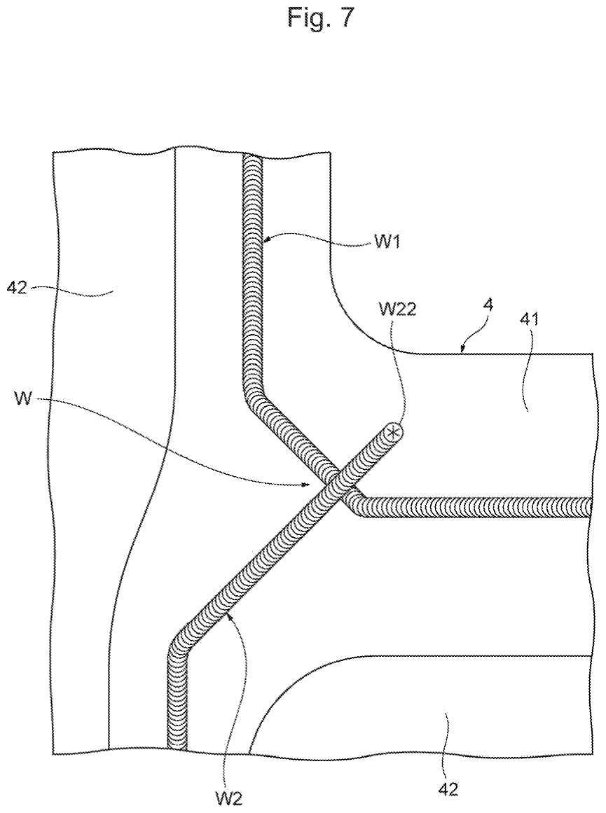

FIG. 7 is an enlarged view of the welded portion W in the VII portion of the welded article 1 of FIG. 4. In the example shown in FIG. 4, the flat portion 41 of the top plate 4 includes an L-shaped peninsular portion extending from the peripheral portion toward the central portion of the top plate 4. In the step of forming the passage forming welded portion W2 in the outside terminating step P2, welding is started from the tip of the peninsular portion of the flat portion 41 of the top plate 4 to form the passage forming welded portion W2 linearly extending from a starting point portion W21.

Then, as shown in FIG. 7, an end point portion W22 of the passage forming welded portion W2 is formed outside of the peripheral welded portion W1 that is the welded portion W surrounding the internal space 2. As a result, it is possible to obtain the same effect as that in the step of forming the end point portion W12 of the peripheral welded portion W1 outside of the peripheral welded portion W1 surrounding the internal space 2 in the above-stated outside terminating step P2.

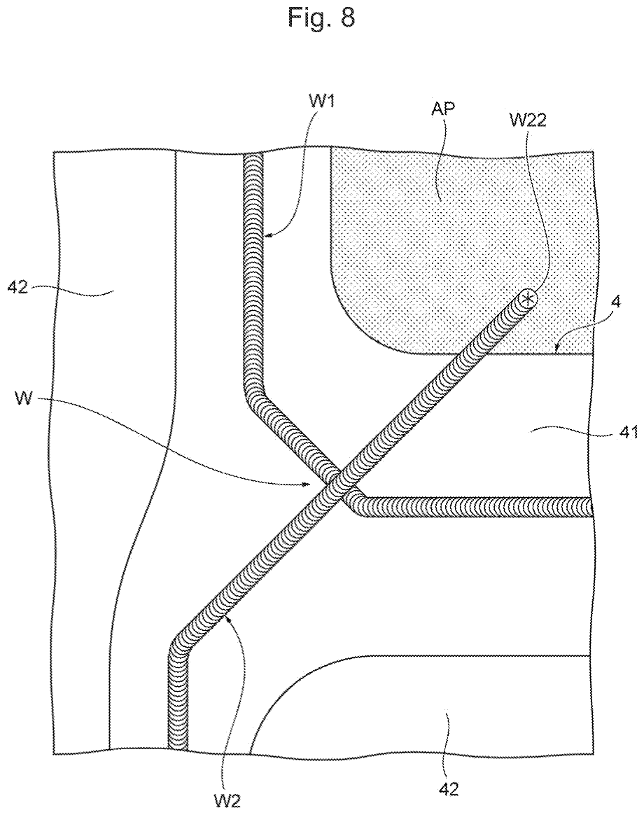

FIG. 8 is an enlarged view of the welded portion W showing a modification of the welded article 1 of FIG. 7. In the step of forming the passage forming welded portion W2 in the outer edge intersecting step P3, like the above-stated outside terminating step P2, welding is started from the tip of the peninsular portion of the flat portion 41 of the top plate 4 to form the passage forming welded portion W2 linearly extending from the starting point portion W21.

Then, as shown in FIG. 8, the passage forming welded portion W2 intersecting the outer edge of the top plate 4 and the underplate 3 is formed by moving the laser in laser welding or the electron beam in electron beam welding from the inside to the outside of the outer edge of the top plate 4 and the underplate 3 that are the members of the welded article 1. In the example of FIG. 8, the auxiliary plate AP is used like the above-stated example shown in FIG. 6. However, this outer edge intersecting step P3 of forming the passage forming welded portion W2 may also be performed without using the auxiliary plate AP.

It should be noted that, as shown in FIG. 4, the passage forming welded portion W2 that is a part of the welded portion W includes a plurality of straight portions W23 extending linearly and one or more curved portions W24 each formed between the adjacent straight portions W23, W23 extending in different directions. In the example shown in FIG. 4, each curved portion W24 is formed into a circular arc, and the contained angle between the straight portions W23, W23 on the opposite sides of each curved portion W24 is equal to 90 degrees or is an obtuse angle greater than 90 degrees.

In the method P for producing a welded article of the present embodiment, after the end of the above-stated outside terminating step P2 or outer edge intersecting step P3 of forming the passage forming welded portion W2, the overlap welding step P4 and the end surrounding step P5 are performed as shown in FIG. 1 for example. The overlap welding step P4 includes, for example, a first overlap welding step P41 and a second overlap welding step P42, and the end surrounding step P5 includes, for example, a first end surrounding step P51 and a second end surrounding step P52.

In the first overlap welding step P41 and the first end surrounding step P51, a passage forming welded portion W3 that is a part of the welded portion W is formed, and in the second overlap welding step P42 and the second end surrounding step P52, a passage forming welded portion W4 that is a part of the welded portion W is formed. As shown in FIG. 4, the passage forming welded portions W3, W4 join the island-shaped flat portion 41 surrounded by the bulging portion 42 of the top plate 4 to the underplate 3, partition the internal space 2 between the bulging portion 42 of the top plate 4 and the underplate 3, and form the refrigerant passage in the welded article 1.

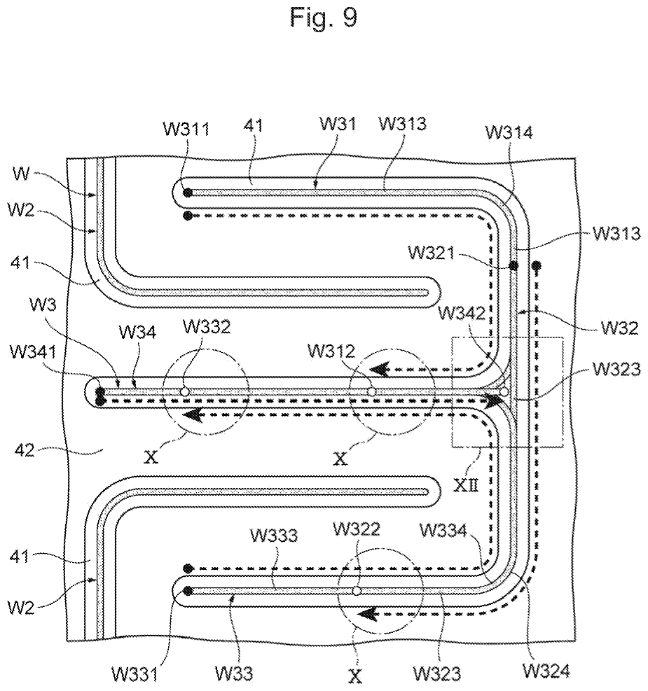

FIG. 9 is an enlarged view of the welded portion W showing the IX portion of the welded article 1 of FIG. 4. The passage forming welded portion W3 that is the welded portion W includes, for example, a first portion W31, a second portion W32, a third portion W33, and a fourth portion W34 that are the welded portions W, partitions the internal space 2 of the welded article 1, and forms the refrigerant passage in the welded article 1 as shown in FIG. 2.

The first portion W31 includes a starting point portion W311 in one of the end portions of the flat portion 41 having a trident or fork shape and an end point portion W312 in the central end portion of the trident flat portion 41 at a position away from its end. In addition, the first portion W31 includes a plurality of straight portions W313 extending linearly and a plurality of curved portions W314 each formed between the adjacent straight portions W313, W313 extending in different directions, and the contained angle between the straight portions W313, W313 on the opposite sides of each curved portion W314 is 90 degrees.

The second portion W32 includes a starting point portion W321 in a base portion opposite to the three end portions of the flat portion 41 having a trident or fork shape. The second portion W32 extends linearly from the starting point portion W321 between one end and the central portion of the base portion of the trident flat portion 41 to the other end of the base portion, is curved in a direction perpendicular to the base portion at the other end of the base portion, and includes an end point portion W322 in one of the three end portions of the trident flat portion 41 at a position away from its end. In addition, the second portion W32 includes two straight portions W323 extending linearly and one curved portion W324 in a circular arc formed between the two straight portions W323 extending in different directions, and the contained angle between the straight portions W323, W323 on the opposite sides of the curved portion W324 is 90 degrees.

The third portion W33 includes a starting point portion W331 in the end portion opposite to the end portion including the starting point portion W311 of the first portion W31, among the two end portions of the trident flat portion 41 on the opposite sides, and includes an end point portion W332 in the central end portion of the trident flat portion 41 at a position away from its end. In addition, the third portion W33 includes a plurality of straight portions W333 extending linearly and a plurality of curved portions W334 each formed between the two straight portions W333, W333 extending in different directions, and the contained angle between the straight portions W333, W333 on the opposite sides of the curved portion W334 is 90 degrees.

The fourth portion W34 includes a starting point portion 341 in the central end portion of the trident flat portion 41, extends linearly toward the base portion of the trident flat portion 41, and includes an end point portion W342 in the central portion of the base portion of the flat portion 41 extending in a direction perpendicular to the fourth portion W34.

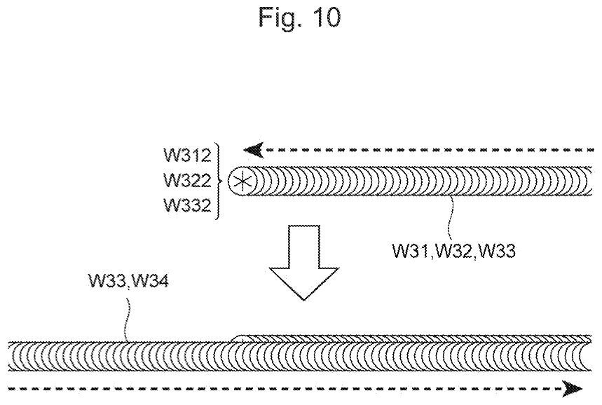

FIG. 10 is an enlarged view of the welded portion W showing the X portion of the welded article of FIG. 9. In the first overlap welding step P41 of forming the passage forming welded portion W3, as shown in FIG. 9 and FIG. 10, first, the first portion W31 is formed to form the end point portion W312, and next, the second portion W32 is formed to form the end point portion W322. Next, as shown in FIG. 9 and FIG. 10, the third portion W33 is formed so as to overlap with the end point portion W322 of the second portion W32, which is one welded portion W, and with the end point portion W312 of the first portion W31, which is one welded portion W. The third portion W33 is another welded portion W.

Finally, the fourth portion W34 is formed, which includes a starting point portion W341 in the central end portion of the trident flat portion 41 and overlaps with the end point portion W332 of the third portion W33 and the end point portion W312 of the first portion W31. Here, each of the third portion W33 and the first portion W31 is one welded portion W, and the fourth portion W34 is another welded portion W overlapping with the end point portions W332, W312 of the respective welded portions W.

As described above, in the first overlap welding step P41, the third portion W33 or the fourth portion W34 is formed as another welded portion W overlapping with the respective end point portions W312, W322, W332 of the first portion W31, the second portion W32, and the third portion W33, which are the welded portions W. Thus, cracking occurring in the end point portions W312, W322, W332 can be repaired by the third portion W33 or the fourth portion W34 formed to overlap with the end point portions W312, W322, W332.

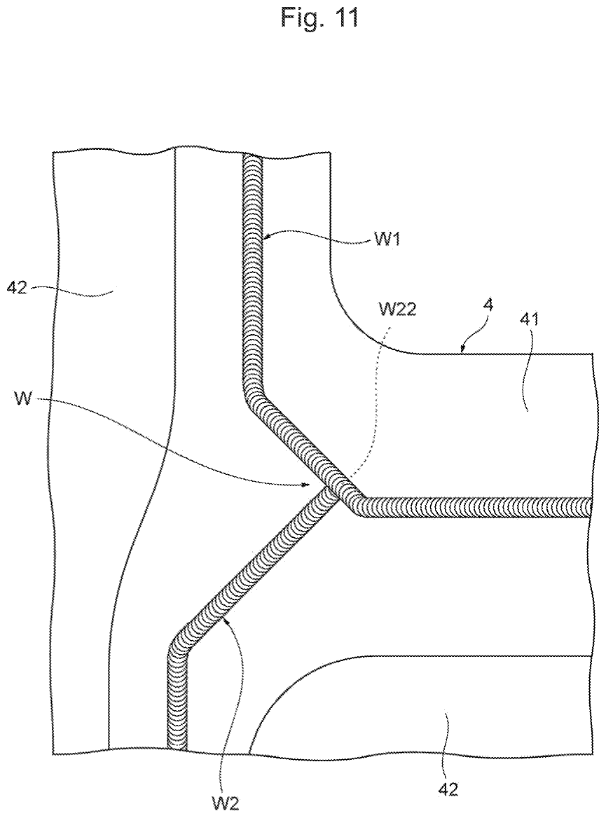

FIG. 11 is an enlarged view of the welded portion W showing a modification of the welded article 1 of FIG. 7. In the example shown in FIG. 7, after forming the peripheral welded portion W1 in the periphery welding step P1, the outside terminating step P2 is performed to form the passage forming welded portion W2. Meanwhile, in the example shown in FIG. 11, the periphery welding step P1 is performed in parallel with the overlap welding step P4.

More specifically, first, like in the above-stated outside terminating step P2, the passage forming welded portion W2 is formed from the end portion of the L-shaped peninsular flat portion 41, which extends from the peripheral portion to the central portion of the top plate 4 shown in FIG. 4, toward the peripheral portion of the top plate 4, and the end point portion W22 is formed in the flat portion 41 in the peripheral portion of the top plate 4. At this time, the end point portion W22 of the passage forming welded portion W2 is formed in a position where the end point portion W22 overlaps with the peripheral welded portion W1 that is to be formed in the periphery welding step P1 performed after the formation of the end point portion W22.

Next, the above-stated periphery welding step P1 is performed to form the peripheral welded portion W1 surrounding the internal space of the welded article 1. At this time, as shown in FIG. 11, the peripheral welded portion W1 is formed so as to overlap with the end point portion W22 of the passage forming welded portion W2 formed in the flat portion 41 in the peripheral portion of the top plate 4. Thus, even when cracking occurs in the end point portion W22 of the passage forming welded portion W2, the cracking occurring in the end point portion W22 of the passage forming welded portion W2 can be repaired by the peripheral welded portion W1 formed to overlap with the end point portion W22.

As shown in FIG. 9, after the formation of the fourth portion W34 that overlaps with the end point portion W332 of the third portion W33 and the end point portion W312 of the first portion W31 in the first overlap welding step P41 of forming the passage forming welded portion W3, the first overlap welding step P41 ends. In the method P for producing a welded article of the present embodiment, after the end of the first overlap welding step P41, the first end surrounding step P51 is consecutively performed.

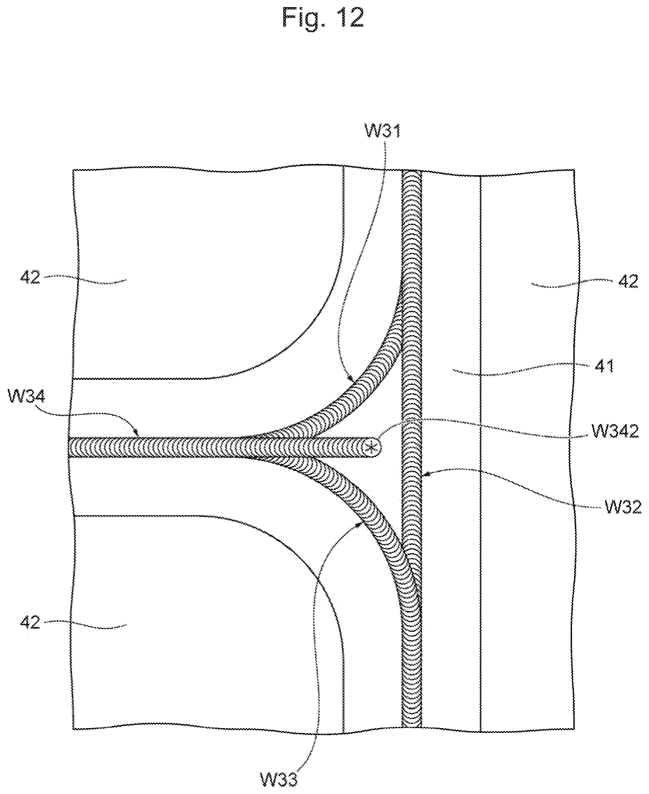

FIG. 12 is an enlarged view of the welded portion W showing the XII portion of the welded article 1 of FIG. 9. In the first end surrounding step P51, the end point portion W342 of the fourth portion W34 is formed in a region surrounded by the first portion W31, the second portion W32, and the third portion W33 of the passage forming welded portion W3 that is the welded portion W partitioning the internal space 2 of the welded article 1.

More specifically, in this first end surrounding step P51, the fourth portion W34, welding of which was started from the central end portion of the trident flat portion 41 of the top plate 4 in the first overlap welding step P41, is continuously formed toward the base portion of the trident flat portion 41. Then, the end point portion W342 of the fourth portion W34 is formed in the region surrounded by the first portion W31, the second portion W32, and the third portion W33 in the base portion of the trident flat portion 41. That is the end of the first end surrounding step P51.

As described above, in the end surrounding step P5, the end point portion W342 of the fourth portion W34 that is the welded portion W is formed in the region surrounded by the first portion W31, the second portion W32, and the third portion W33, which are the welded portions W partitioning the internal space 2 of the welded article 1. Thus, even when cracking occurs in the end point portion W342, the influence of the cracking on the internal space 2 of the welded article 1 can be avoided. As shown in FIG. 1, in the method P for producing a welded article of the present embodiment, next, the second overlap welding step P42 and the second end surrounding step P52 are performed.

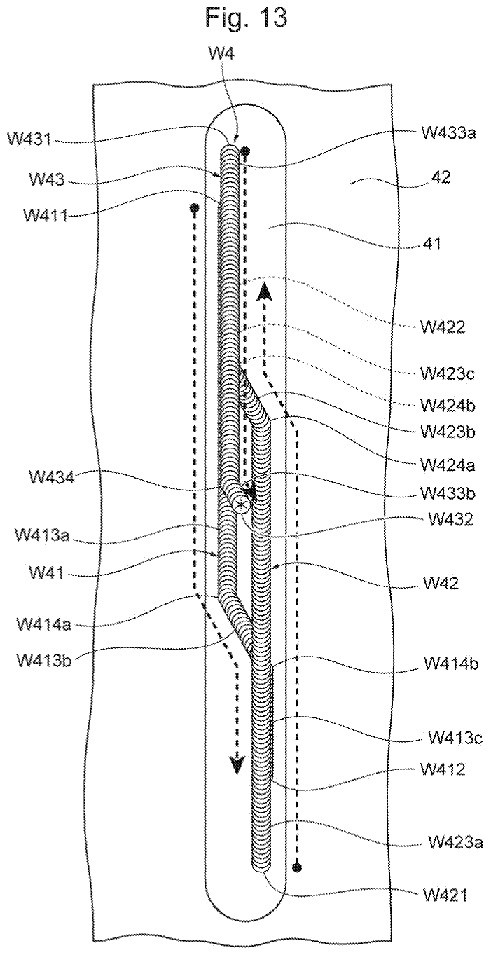

FIG. 13 is an enlarged view of the welded portion W showing the XIII portion of the welded article of FIG. 4. In the second overlap welding step P42 and the second end surrounding step P52, a passage forming welded portion W4 shown in FIG. 4 and FIG. 13 is formed. The passage forming welded portion W4 that is the welded portion W includes, for example, a first portion W41, a second portion W42, and a third portion W43 that are the welded portions W, partitions the internal space 2 between the bulging portion 42 of the top plate 4 and the underplate 3, and forms the refrigerant passage in the welded article 1.

The first portion W41 includes a starting point portion W411 formed at one end portion of the flat portion 41 having an elongated shape, and an end point portion W412 formed at the other end portion of the flat portion 41. In addition, the first portion W41 includes a straight portion W413a extending linearly from the starting point portion W411 toward the end point portion W412, a straight portion W413b extending linearly in a direction different from the straight portion W413a, and a straight portion W413c extending linearly in a direction different from the straight portion W413b.

In addition, the first portion W41 includes a curved portion W414a between the straight portion W413a and the straight portion W413b, and includes a curved portion W414b between the straight portion W413b and the straight portion W413c. The contained angle between the straight portion W413a and the straight portion W413b on the opposite sides of the curved portion W414a and the contained angle between the straight portion W413b and the straight portion W413c on the opposite sides of the curved portion W414b are each an obtuse angle of 90 degrees or greater.

The second portion W42 includes a starting point portion W421 formed at one end portion of the flat portion 41 having an elongated shape opposite to the end portion where the starting point portion W411 of the first portion W41 is formed, and an end point portion W422 formed nearer to the center of the flat portion 41 than the starting point portion W411 of the first portion W41 at the end portion of the flat portion 41 opposite to the starting point portion W421. In addition, the second portion W42 includes a straight portion W423a extending linearly from the starting point portion W421 toward the end point portion W422, a straight portion W423b extending linearly in a direction different from the straight portion W423a, and a straight portion W423c extending linearly in a direction different from the straight portion W423b.

In addition, the second portion W42 includes a curved portion W424a between the straight portion W423a and the straight portion W423b, and includes a curved portion W424b between the straight portion W423b and the straight portion W423c. The contained angle between the straight portion W423a and the straight portion W423b on the opposite sides of the curved portion W424a and the contained angle between the straight portion W423b and the straight portion W423c on the opposite sides of the curved portion W424b are each an obtuse angle of 90 degrees or greater.

The third portion W43 includes a starting point portion W431 formed in a position nearer to the edge in a longitudinal direction at one end portion of the flat portion 41 having an elongated shape than the starting point portion W411 of the first portion W41, and an end point portion W432 formed in the central portion of the flat portion 41 in the longitudinal direction. The end point portion W432 of the third portion W43 is formed in a region surrounded by the first portion W41 and the second portion W42 of the passage forming welded portion W4 partitioning the internal space 2 of the welded article 1.

In addition, the third portion W43 includes a straight portion W433a extending linearly from the starting point portion W431 to the end point portion W432 and a straight portion W433b extending linearly in a direction different from the straight portion W433a. In addition, the third portion W43 includes a curved portion W434 between the straight portion W433a and the straight portion W433b. The contained angle between the straight portion W433a and the straight portion W433b on the opposite sides of the curved portion W434 is an obtuse angle of 90 degrees or greater.

In the second overlap welding step P42, first, the first portion W41 of the passage forming welded portion W4 is formed in the elongated island-shaped flat portion 41 of the top plate 4. Next, the second portion W42 is formed as another welded portion W overlapping with the end point portion W412 of the first portion W41 that is one welded portion W. Finally, the third portion W43 is formed as one welded portion W overlapping with the end point portion W422 of the second portion W42 that is another welded portion W.

As described above, in the second overlap welding step P42, even when cracking occurs in the end point portions W412, W422, the cracking can be repaired by the second portion W42 formed to overlap with the end point portion W412 of the first portion W41 and the third portion W43 formed to overlap with the end point portion W422 of the second portion W42.

In the method P for producing a welded article of the present embodiment, after the end of the second overlap welding step P42, the second end surrounding step P52 is consecutively performed. In the second end surrounding step P52, the end point portion W432 of the third portion W43 is formed in the region surrounded by the first portion W41 and the second portion W42 of the passage forming welded portion W4, which is the welded portion W partitioning the internal space 2 of the welded article 1. That is the end of the second end surrounding step P52, and the method P for producing a welded article shown in FIG. 1 ends.

As described above, in the end surrounding step P5, the end point portion W432 of the third portion W43 is formed in the region surrounded by the first portion W41 and the second portion W42, which are the welded portions W partitioning the internal space 2 of the welded article 1. Thus, even when cracking occurs in the end point portion W432, the influence of the cracking on the internal space 2 of the welded article 1 can be avoided.

As described above, the method P for producing a welded article of the present embodiment welds a plurality of members by laser welding or electron beam welding to form the welded portion W and produce the welded article 1 having the internal space 2. The method P for producing a welded article of the present embodiment includes the periphery welding step P1 of forming the welded portion W surrounding the internal space 2. The method P for producing a welded article of the present embodiment further includes at least one of the outside terminating step P2, the outer edge intersecting step P3, the overlap welding step P4, or the end surrounding step P5. In the outside terminating step P2, the end point portions W12, W22 of the welded portions W are formed outside of the welded portion W surrounding the internal space 2 as shown in FIG. 5 and FIG. 7. In the outer edge intersecting step P3, the welded portion W is formed by moving the laser in laser welding or the electron beam in electron beam welding from the inside to the outside of the outer edge of the plurality of members of the welded article 1 as shown in FIG. 6 and FIG. 8. In the overlap welding step P4, the third portion W33, the fourth portion W34, and the like that are other welded portions W overlapping with the end point portion W312 of one welded portion W and the like are formed as shown in FIG. 10. In the end surrounding step P5, the end point portions W342, W432 of the welded portions W are formed in the region surrounded by the first portion W31 that is the welded portion W partitioning the internal space 2 and the like as shown in FIG. 12 and FIG. 13.

With such a configuration, the method P for producing a welded article of the present embodiment does not require a preparation work of forming a filler metal coating such as in the above-described conventional method for joining aluminum members, and can simplify welding. In addition, the method P for producing a welded article of the present embodiment does not require friction stir joining as in the above-stated conventional bus bar, and thus is easily applied even if the number of welding spots relative to the area of the members of the welded article 1 increases. In addition, since the end point portions W12, W22 of the welded portions W are formed outside of the welded portion W surrounding the internal space 2 of the welded article 1 in the outside terminating step P2, even when cracking occurs in the end point portions W12, W22 of the linear welded portions W, the influence of the cracking on the internal space 2 of the welded article 1 can be avoided. In addition, as shown in FIG. 6 or FIG. 8, since the end point portions W12, W22 of the welded portions W are not formed in the members of the welded article 1 in the outer edge intersecting step P3, even when cracking occurs in the end point portions W12, W22 of the welded portions W, the influence of the cracking on the internal space 2 of the welded article 1 can be avoided. In addition, as shown in FIG. 10 and FIG. 13, since another welded portion W is formed to overlap with the end point portions W312, W322, W332, W412, W422 of the welded portions W in the overlap welding step P4, the cracking occurring in the end point portions W312, W322, W332, W412, W422 can be repaired. Thus, the influence of the cracking occurring in the end point portions W312, W322, W332, W412, W422 on the internal space 2 of the welded article 1 can be avoided. In addition, as shown in FIG. 12 and FIG. 13, since the end point portions W342, W432 of the welded portions W are formed in the region surrounded by the welded portions W partitioning the internal space 2 in the end surrounding step P5, even when cracking occurs in the end point portions W342, W432, the influence of the cracking on the internal space 2 of the welded article 1 can be avoided.

In addition, the method P for producing a welded article of the present embodiment includes at least the outside terminating step P2 or the outer edge intersecting step P3. With such a configuration, according to the method P for producing a welded article of the present embodiment, as shown in FIG. 4, the welded article 1 may include, as the welded portion W, the peripheral welded portion W1 surrounding the internal space 2 in the peripheral portion of the top plate 4. In addition, with such a configuration, the welded article 1 may include the passage forming welded portion W2 partitioning the internal space 2 to form the refrigerant passage in the welded article 1 in the peninsular flat portion 41 extending from the peripheral portion to the central portion of the top plate 4.

In addition, the method P for producing a welded article of the present embodiment includes at least the overlap welding step P4 and the end surrounding step P5. With such a configuration, according to the method P for producing a welded article of the present embodiment, as shown in FIG. 4, the welded article 1 may include, as the welded portions W, the passage forming welded portion W3 and the passage forming welded portion W4 partitioning the internal space 2 to form the refrigerant passage in the welded article 1 in the island-shaped flat portion 41 surrounded by the bulging portion 42 of the top plate 4.

In addition, in the method P for producing a welded article of the present embodiment, the peripheral welded portion W1 of the welded portion W includes, for example, the straight portions W13 extending linearly and the curved portion W14 formed between the straight portions W13, W13 extending in different directions. The contained angle between the straight portions W13, W13 on the opposite sides of the curved portion W14 is 90 degrees or greater. With such a configuration, the method P for producing a welded article of the present embodiment can reduce thermal stress acting on the welded portion W from the non-welded portion of the top plate 4 and the underplate 3 between the straight portions W13, W13 extending in different directions, and prevent occurrence of cracking in the welded portion W. In addition, the same effect can be obtained in the passage forming welded portion W2, the passage forming welded portion W3, and the passage forming welded portion W4 other than the peripheral welded portion W1 of the welded portion W.

As described above, according to the present embodiment, it is possible to provide the method P for producing a welded article, which is easily applied even with an increased number of welding spots, simplifies welding, and can avoid an influence of weld cracking that may occur in the end point portion W12 or the like of the linear welded portion W on the internal space 2 of the welded article 1.

Although the embodiment of the method for producing a welded article of the present disclosure has been described in detail above with reference to the drawings, specific structures are not limited thereto, and any design changes that fall within the spirit and scope of the present disclosure are encompassed by the scope of the present disclosure.

### DESCRIPTION OF SYMBOLS

1 Welded article
2 Internal space
3 Underplate (member)
4 Top plate (member)
P Method for producing welded article
P1 Periphery welding step
P2 Outside terminating step
P3 Outer edge intersecting step
P4 Overlap welding step
P5 End surrounding step
W Welded portion
W1 Peripheral welded portion (welded portion)
W12 End point portion
W13 Straight portion
W14 Curved portion
W2 Passage forming welded portion (welded portion)
W22 End point portion
W23 Straight portion
W24 Curved portion
W3 Passage forming welded portion (welded portion)
W312 End point portion
W313 Straight portion
W314 Curved portion
W322 End point portion
W323 Straight portion
W324 Curved portion
W332 End point portion
W333 Straight portion
W334 Curved portion
W342 End point portion
W4 Passage forming welded portion (welded portion)
W412 End point portion
W413a Straight portion
W413b Straight portion
W413c Straight portion
W414a Curved portion
W414b Curved portion
W422 End point portion
W423a Straight portion
W423b Straight portion
W423 c Straight portion
W424a Curved portion
W424b Curved portion
W432 End point portion
W433a Straight portion
W433b Straight portion
W434 Curved portion

What is claimed is:

1. A method for producing a welded article by welding a plurality of members by laser welding or electron beam welding to form a welded portion and produce a welded article having an internal space, the method comprising:
a periphery welding step of forming the welded portion surrounding the internal space,
the method further comprising at least one of
an outside terminating step of forming an end point portion of the welded portion outside of the welded portion surrounding the internal space,
an outer edge intersecting step of forming the welded portion by moving a laser in the laser welding or an electron beam in the electron beam welding from an inside to an outside of an outer edge of the plurality of members,
an overlap welding step of forming another welded portion overlapping with the end point portion of the welded portion previously formed, or
an end surrounding step of forming the end point portion of the welded portion in a region surrounded by the welded portion partitioning the internal space.

2. The method for producing a welded article according to claim 1, comprising at least the outside terminating step or the outer edge intersecting step.

3. The method for producing a welded article according to claim 1, comprising at least the overlap welding step and the end surrounding step.

4. The method for producing a welded article according to claim 1, wherein the welded portion includes straight portions extending linearly and a curved portion formed between the straight portions extending in different directions, and
a contained angle between the straight portions on opposite sides of the curved portion is 90 degrees or greater.
